(19) United States
(12) Patent Application Publication
(10) Pub. No.: US 2008/0273641 A1
(43) Pub. Date: Nov. 6, 2008

(54) OFDM-BASED DEVICE AND METHOD FOR PERFORMING SYNCHRONIZATION

(76) Inventors: Jingnong Yang, Santa Clara, CA (US); Youhan Kim, Albany, CA (US); Won-Joon Choi, Cupertino, CA (US)

Correspondence Address: Wilson & Ham, 2530 Berryessa Road, PMB: 348, San Jose, CA, 95132, US

(21) Appl. No.: 12/114,949

(22) Filed: May 5, 2008

Related U.S. Application Data
(60) Provisional application No. 60/927,497, filed on May 4, 2007.

(51) Int. Cl. H04L 7/02

(52) U.S. Cl. 375/359; 375/260

(57) ABSTRACT

An OFDM-based device and method for synchronizing to a serving base station utilizes at least one of three frequency offset estimation techniques, which are each based on preambles, cyclic prefixes or pilot subcarriers. The device and method also utilizes a base station selecting scheme, a false detection scheme, a blocker detection scheme to provide robust synchronization.

### CROSS REFERENCE TO RELATED APPLICATION

This application is entitled to the benefit of U.S. Provisional Patent Application Ser. No. 60/927,497, filed on May 4, 2007, which is incorporated herein by reference.

### BACKGROUND OF THE INVENTION

Orthogonal Frequency Division Multiple Access (OFDMA) technology is popular in modern communication systems since this technology can efficiently support multiple mobile stations with limited bandwidth and easily provide Quality of Service (QoS). The OFDMA technology is a multiple access version of orthogonal frequency-division multiplexing (OFDM). OFDM is a modulation technique for data transmission based on frequency-division multiplexing (FDM), which uses different frequency channels to transmit multiple streams of data. In OFDM systems, a wideband channel is divided into multiple narrow-band orthogonal “subcarriers” in the frequency domain, each of which is modulated by digital signal in parallel.

In OFDMA systems, multiple subscribers can simultaneously use different subcarriers for signal transmission. Thus, in an OFDMA system, multiple data bursts can be transmitted from a base station (BS) to multiple mobile stations in the same time frame but allocated in different frequency subcarriers. Consequently, an OFDMA system can support multiple mobile stations using different subcarriers.

At a transmitter of an OFDMA system, input information is assembled into blocks of N complex symbols, one for each subcarrier. An N-point inverse Fast Fourier Transform (FFT) is then performed on each block, and the resultant time domain signal is transmitted. Usually, several blocks are grouped to form a frame, and one extra block with known pattern, which is referred to as the “preamble”, is inserted into the beginning of every frame for signal detection, synchronization and channel estimation purposes.

At a receiver of the OFDMA system, the presence of signal needs to be detected and the starting point of a frame needs to be estimated. In addition, a BS needs to be detected and set as the serving BS. Furthermore, in order to synchronize to the transmitter, frequency offset from the serving BS needs to be estimated. The frequency offset estimate can then be used to synchronize to the serving BS.

In view of these requirements, there is a need for an OFDM-based device and method for performing synchronization in a robust manner.

### SUMMARY OF THE INVENTION

An OFDM-based device and method for synchronizing to a serving base station utilizes at least one of three frequency offset estimation techniques, which are each based on preambles, cyclic prefixes or pilot subcarriers. The device and method also utilizes a base station selecting scheme, a false detection scheme, a block detection scheme to provide robust synchronization.

A method for performing synchronization for an OFDM-based device in accordance with an embodiment of the invention comprises receiving an incoming OFDM-based signal with preambles, cyclic prefixes and pilot subcarriers, and producing a frequency offset estimate using at least one of the preambles, cyclic prefixes and pilot subcarriers, the frequency offset estimate being used for synchronization. The producing of the frequency offset estimate including at least one of: (a) computing a preamble-based frequency offset estimate using a particular preamble of the incoming OFDM-based signal, the particular preamble including first, second and third slots, the computing the preamble-based frequency offset estimate including computing a phase difference between the first slot and third slot and a phase difference between a first block of the first and second slots and a second block of the second and third slots; (b) computing a cyclic prefix-based frequency offset estimate using a particular cyclic prefix of an OFDM-based symbol in the incoming OFDM-based signal, the computing the cyclic prefix-based frequency offset estimate including computing a correlation between at least a portion of the particular cyclic prefix with a corresponding end portion of the OFDM-based symbol; and (c) computing a pilot-based frequency offset estimate using some of the pilot subcarriers in the incoming OFDM-based signal, the computing the pilot-based frequency offset estimate including computing a phase difference between pilot subcarriers at a particular subcarrier location and in different OFDM-based symbols and averaging phase differences across multiple pilot subcarrier locations and across multiple OFDM-based symbols.

An OFDM-based device in accordance with an embodiment of the invention comprises a frequency offset estimator configured to produce a frequency offset estimate using at least one of preambles, cyclic prefixes and pilot subcarriers of an OFDM-based signal. The frequency offset estimator comprises at least one of a preamble-based frequency offset estimator, a cyclic prefix-based frequency offset estimator and a pilot-based frequency offset estimator. The preamble-based frequency offset estimator is configured to compute a preamble-based frequency offset estimate using a particular preamble of the incoming OFDM-based signal. The particular preamble includes first, second and third slots. The preamble-based frequency offset estimator is configured to compute a phase difference between the first slot and third slot and a phase difference between a first block of the first and second slots and a second block of the second and third slots to compute the preamble-based frequency offset estimate. The cyclic prefix-based frequency offset estimator is configured to compute a cyclic prefix-based frequency offset estimate using a particular cyclic prefix of an OFDM-based symbol in the incoming OFDM-based signal. The cyclic prefix-based frequency offset estimator is configured to compute a correlation between at least a portion of the particular cyclic prefix with a corresponding end portion of the OFDM-based symbol to compute the cyclic prefix-based frequency offset estimate. The pilot-based frequency offset estimator is configured to compute a pilot-based frequency offset estimate using some of the pilot subcarriers in the incoming OFDM-based signal. The pilot-based frequency offset estimator is configured to compute a phase difference between the pilot subcarriers at a particular subcarrier location and in different OFDM-based symbols and average phase differences across multiple pilot subcarrier locations and across multiple OFDM-based symbols.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a device based on Orthogonal Frequency Division Multiple (OFDMA) in accordance with an embodiment of the invention.

FIG. 2 is a block diagram of a synchronization module in the device of FIG. 1 in accordance with an embodiment of the invention.

FIG. 3 is a block diagram of a frequency offset estimator in the synchronization module of FIG. 2 in accordance with an embodiment of the invention.

FIG. 4 is a diagram of a preamble of an OFDMA signal in the time domain.

FIG. 5 is a diagram of an OFDMA symbol with a cyclic prefix.

FIG. 6 is a diagram of a frequency-domain preamble in a WiMAX system.

FIG. 7 is a diagram of a procedure for estimating CINR in accordance with an embodiment of the invention.

FIG. 8 is a flow diagram of a method for performing synchronization in an OFDM-based device in accordance with an embodiment of the invention.

### DETAILED DESCRIPTION

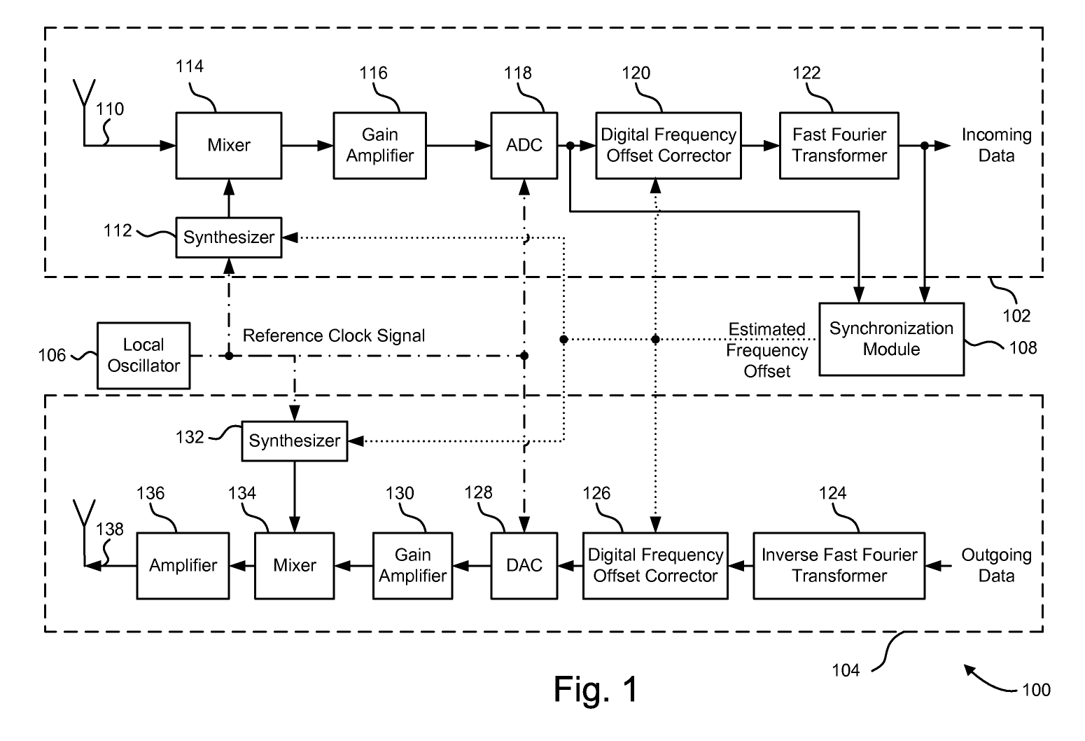

With reference to FIG. 1, a device 100 based on Orthogonal Frequency Division Multiple (OFDM) in accordance with an embodiment of the invention is described. In this embodiment, the OFDM-based device 100 is a mobile station of an Orthogonal Frequency Division Multiple Access (OFDMA) system that receives incoming OFDM signals from a base station (BS) of the system and transmits outgoing OFDM signals to the BS. As described in more detail below, the OFDM-based device 100 is configured to estimate the frequency offset with respect to the BS using preambles, cyclic prefixes and/or pilot subcarriers of the incoming OFDM signals and then to apply the estimated frequency offset in both analog and digital domains to correct for synchronization errors due to the frequency offset in the presence of fading channels and/or interference signals.

As shown in FIG. 1, the OFDM-based device 100 includes a receiver 102, a transmitter 104, a local oscillator 106 and a synchronization module 108. The receiver 104 operates to receive incoming OFDM signals from the BS and then to process the received signals to extract the incoming data embedded in the signals. The transmitter 104 operates to process outgoing data to produce outgoing OFDM signals and then to transmit the signals to the BS. The local oscillator 106 is configured to generate a reference clock signal, which is used in the receiver 102 and the transmitter 104. The synchronization module 108 operates to produce a frequency offset estimate signal, which is used at the receiver 102 and the transmitter 104 to correct for synchronization errors due to frequency offset in the incoming and outgoing signals. The synchronization module 108 also operates to calculate carrier-to-interference-plus-noise-ratio (CINR), select a serving BS, identify false detection and detect blockers. The synchronization module 108 is described in more detail below.

As shown in FIG. 1, the receiver 102 includes a receiving antenna 110, a synthesizer 112, a mixer 114, a gain amplifier 116, an analog-to-digital converter (ADC) 118, a digital frequency offset corrector 120 and a fast Fourier transformer 122. The receiver 102 further includes other components commonly found in an OFDM-based receiver. However, these other components are not described herein so that the inventive features of the invention are not obscured.

The synthesizer 112 is connected to the local oscillator 106 to receive the reference clock signal. The synthesizer 112 is also connected to the synchronization module 108 to receive a frequency offset estimate in the form of a signal from the synchronization module. The frequency offset estimate from the synchronization module 108 is used to compensate for the frequency offset between the reference clock signal of the local oscillator 106 and the clock signal used at the transmitting BS. The synthesizer 112 is configured to adjust the resulting mixer signal using the frequency offset estimate signal to compensate for the frequency offset of the reference clock signal. As an example, the synthesizer 112 may use a fractional phase lock loop to produce a frequency offset-compensated mixer signal. However, other known techniques may be utilized to produce the frequency offset-compensated mixer signal using the reference clock signal and the frequency offset estimate signal.

The receiving antenna 110 is used to receive an incoming OFDM signal from the BS. Although the receiver 102 is shown with a single receive antenna, the receiver may include multiple receive antennas for multi-input multi-output (MIMO) communication. The mixer 114 is configured to mix the received incoming OFDM signal with the frequency offset-compensated mixer signal from the synthesizer 112 to down convert the frequency of the incoming OFDM signal to the baseband frequency. The gain amplifier 16 is configured to amplify the down-converted signal. The ADC 118 is configured to convert the amplified down-converted signal from an analog signal into a digital signal. The ADC 118 is connected to the local oscillator 106 to receive the reference clock signal, which is used as the sampling clock signal for converting the down-converted signal into a digital signal. Since the reference clock signal from the local oscillator 106 is not corrected for frequency offset, the resulting digital signal includes sampling errors due to the frequency offset of the reference clock signal.

The digital frequency offset corrector 120 operates to receive the digital down-converted signal from the ADC 118 and correct the sampling errors in the digital down-converted signal using the estimated frequency offset from the frequency offset estimator 108. In an embodiment, the digital frequency offset corrector 120 is connected to the ADC 118 and positioned before the fast Fourier transformer 122, as illustrated in FIG. 1. Thus, in this embodiment, the digital frequency offset corrector 120 operates in the time domain. In this embodiment, the digital frequency offset corrector 120 is configured to digitally resample the digital down-converted signal at a frequency offset-compensated sampling rate (i.e., frequency of the reference clock signal without frequency offset), which is derived using the estimated frequency offset signal from the synchronization module 108, so that the sampling errors can be corrected.

In this embodiment, the fast Fourier transformer 122 is connected to the digital frequency offset corrector 120 to receive the sampling error-corrected signal. The fast Fourier transformer 122 is configured to perform fast Fourier transform on the OFDM symbols in the received signal. The fast Fourier transformer 122 may also be connected to the synchronization module 108 to receive symbol timing error estimations, which are based on frequency offset estimates. The estimated symbol timing error may be used by the fast Fourier transformer 122 to determine the boundaries of the OFDM symbols to properly convert the OFDM symbols into frequency components, which are further processed to extract the data in the received signal.

In another embodiment, the digital frequency offset corrector 120 is positioned after the fast Fourier transformer 122. Thus, in this embodiment, the digital frequency offset corrector 120 operates in the frequency domain. In this embodiment, the digital frequency offset corrector 120 is configured to correct linear phase shift from one OFDM symbol to another. The linear phase shift is caused by the sampling errors introduced into the digital down-converted signal at the ADC 118 due to the reference clock signal from the local oscillator 106. Using the estimated frequency offset signal from the frequency offset estimator 108, the digital frequency offset corrector 120 is configured to calculate the sampling time error. The linear phase shift can then be calculated from the sampling time error and be corrected by the digital frequency offset corrector 120.

In the illustrated embodiment, the synchronization module 108 is connected to the receiving signal path at a node between the ADC 118 and the frequency offset corrector 120 to process the incoming signal in the time domain to use preambles and/or cyclic prefixes in the incoming signal. The synchronization module 108 is also connected to the receiving signal path at a node after the Fast Fourier Transformer 122 to process the incoming signal in the frequency domain to use pilot subcarriers in the incoming signal.

The transmitter 104 of the OFDM-based device 100 includes an inverse fast Fourier transformer 124, a digital frequency offset corrector 126, a digital-to-analog converter (DAC) 128, a gain amplifier 130, a synthesizer 132, a mixer 134, an amplifier 136 and a transmitting antenna 138. The inverse fast Fourier transformer 124 receives data to be transmitted and transforms the data from frequency components into time domain waveform, thereby converting the data from the frequency domain into the time domain.

The digital frequency offset corrector 126 is connected to the inverse fast Fourier transformer 124 to receive the time domain waveform, which is a digital outgoing OFDM signal. The digital frequency offset corrector 126 is also connected to the synchronization module 108 to receive a signal containing the frequency offset estimate. The digital frequency offset corrector 126 operates to digitally resample the digital outgoing signal at the correct sampling rate using the frequency offset estimate in anticipation of sampling errors that will be introduced at the DAC 128.

The DAC 128 is connected to the digital frequency offset corrector 126 to receive the digital outgoing signal, which has now been corrected in anticipation of sampling errors. The DAC 128 is also connected to the local oscillator 106 to receive the reference clock signal. The DAC 128 converts the digital outgoing signal into an analog signal using the reference clock signal as the sampling clock signal. The resulting analog signal is then amplified by the gain amplifier 130 and transmitted to the mixer 134.

The mixer 134 is connected to the gain amplifier 130 to receive the analog outgoing signal. The mixer 134 operates to mix the analog outgoing signal with a frequency offset-compensated mixer signal to up convert the analog outgoing signal for wireless transmission. In an embodiment, the mixer 134 is connected to the synthesizer 132 to receive the frequency offset-compensated mixer signal. Similar to the synthesizer 112 of the receiver 102, the synthesizer 132 is connected to the local oscillator 106 to receive the reference clock signal, which is used to produce the mixer signal. The synthesizer 132 is also connected to the synchronization module 108 to receive the frequency offset estimate signal, which is used to compensate for the frequency offset. As an example, the synthesizer 132 may use a fractional phase lock loop to produce the frequency offset-compensated mixer signal. However, other known techniques may be utilized to produce the frequency offset-compensated mixer signal using the reference clock signal and the frequency offset signal estimate.

In an alternative embodiment, the mixer 134 may be connected to the synthesizer 112 of the receiver 102 to receive the frequency offset-compensated mixer signal from that synthesizer. In this embodiment, the synthesizer 132 is not needed, and thus, can be removed from the OFDM-based device 100.

The up-converted outgoing signal is then amplified by the amplifier 136 and transmitted via the transmitting antenna 138. In an alternative embodiment, the outgoing signal is transmitted using the antenna 110, which is used to both receive and transmit OFDM signals. In this embodiment, the transmitting antenna 138 is not needed, and thus, can be removed from the OFDM-based device 100.

Various components of the OFDM-based device 100 represent functional blocks that can be implemented in any combination of software, hardware and firmware. In addition, some of these components of the OFDM-based device 100 may be combined or divided so the OFDM-based device includes fewer or more components than described and illustrated herein.

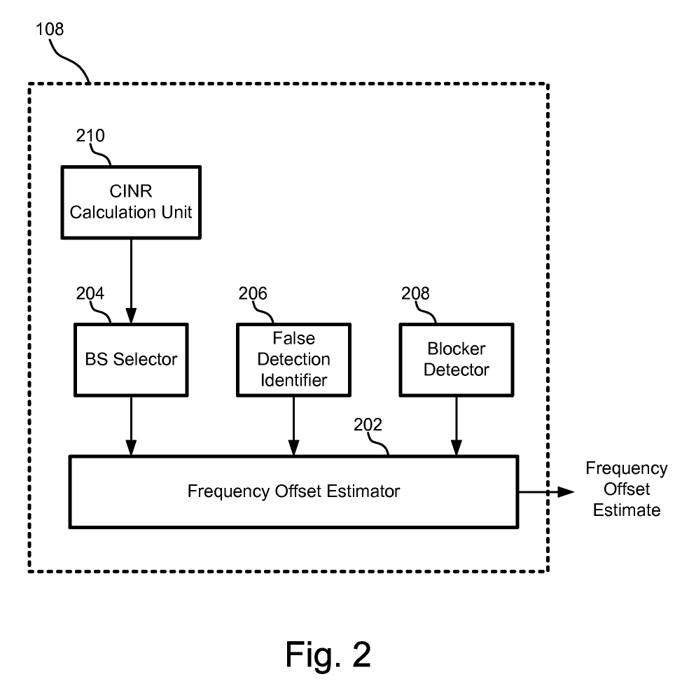

Turning now to FIG. 2, components of the synchronization module 108 are shown. The synchronization module 108 includes a frequency offset estimator 202, a BS selector 204, a false detection identifier 206, a blocker detector 208 and a CINR calculation unit 210. These components of the synchronization module 108 are described in detail below.

The frequency offset estimator 202 is configured to compute a frequency offset estimate using the incoming signal. The frequency offset estimator 202 computes the frequency offset estimate based on preambles, cyclic prefixes (CPs) and pilot subcarriers in OFDM signals, as explained below.

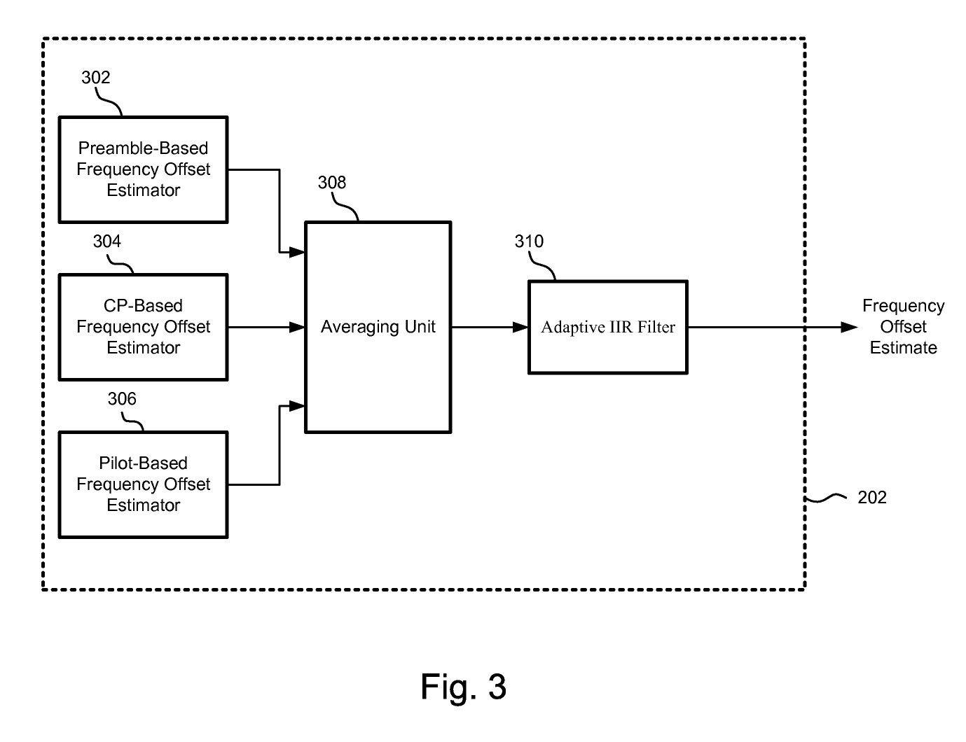

Turning now to FIG. 3, components of the frequency offset estimator 202 in accordance with an embodiment of the invention are illustrated. As shown in FIG. 3, the frequency offset estimator 108 includes a preamble-based frequency offset estimator 302, a CP-based frequency offset estimator 304, a pilot-based frequency offset estimator 306, an averaging unit 308 and an optional adaptive Infinite Impulse Response (IIR) filter 310. In this embodiment, the frequency offset estimator 202 is configured to use all three frequency offset estimates, i.e., the preamble-based frequency offset estimate, CP-based frequency offset estimate and the pilot-based frequency offset estimate, to produce the final frequency offset estimate.

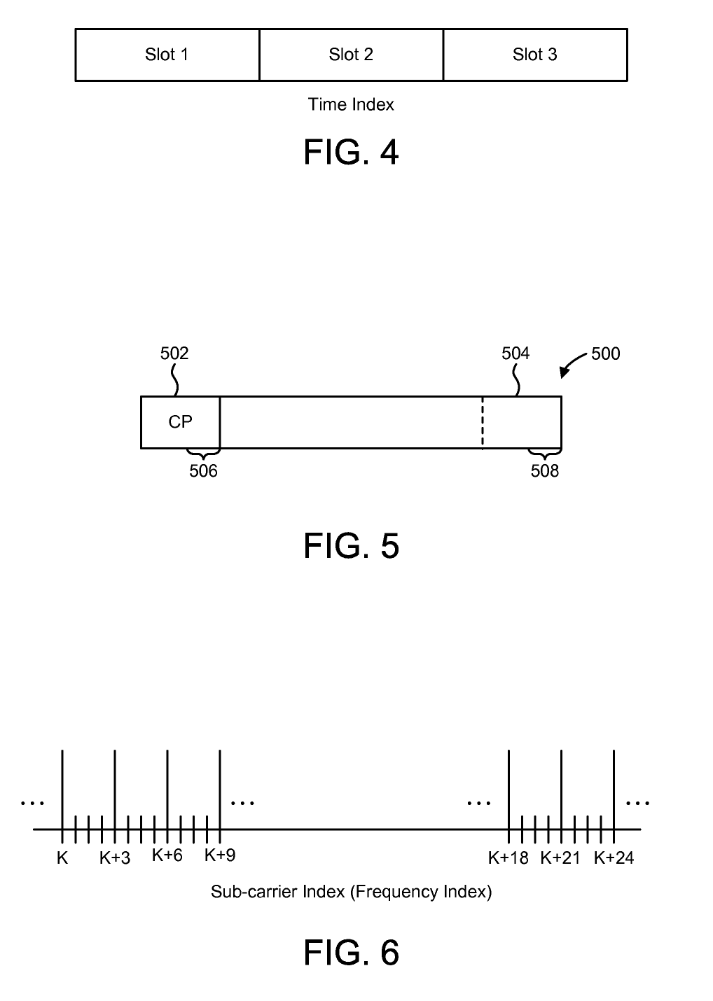

The preamble-based frequency offset estimator 302 is configured to compute the preamble-based frequency offset estimate. OFDM signals include preamble symbols (referred to herein as “preambles”), which are predefined repetitive sequences. In the time domain, a preamble can be divided into three slots: slot 1, slot 2 and slot 3, as shown in FIG. 4. Each slot occupies one-third of the preamble length. In the ideal case of no frequency offset, i.e., in the absence of frequency offset, the three slots of the preamble are identical except for a known phase difference between the slots, which can be corrected in either time or frequency domain. In the presence of frequency offset, the received signals in the three slots of the preamble are no longer the same. Thus, the signals in the preamble can be used to estimate the frequency offset.

The mathematical basis of a computing operation performed by the preamble-based frequency offset estimator 302 to compute the preamble-based frequency offset estimate is now described. Let r₁ be the self-correlation between the first slot block, i.e., the slots 1 and 2, and the second slot block, i.e., the slots 2 and 3, of the time-domain preamble and φ₁ be the phase of r₁, i.e., r₁=e^{jφ}^{₁}. Let r₂ be the self-correlation between the slot 1 and the slot 3 of the time-domain preamble and φ₂ be the phase of r₂, i.e., r₂=e^{jφ}^{₂}. Now, a quantity φ₃ is computed using one of two methods.

The first method of computing φ₃ uses r₁ and r₂. This first method involves defining r₃=r₁r₂ and letting φ₃ be the phase of r₃, i.e., r₃=e^{jφ}^{₃}. Thus, in this method, φ₃ is computed by calculating the phase of r₃.

The second method of computing φ₃ uses φ₁ and φ₂. This second method involves defining φ₃=φ₁+φ₂. However, the resultant phase has an ambiguity problem because a phase difference beyond a range of −π to +π is wrapped around, which creates ambiguity in estimating a large frequency offset. To resolve the ambiguity, the following processing is done:

```
if φ₃ > π
  φ₃ = φ₃ − 2π
else if φ₃ < −π
  φ₃ = φ₃ + 2π
end
```

The preamble-based frequency offset estimate, f_{preamble}, can be computed using:

$${f}_{preamble} = \frac{{ϕ}_{3}}{2 π} Δ f , \qquad ( Equation 1 )$$

where Δf is the subcarrier spacing. Thus, the computed f using φ₃ is the preamble-based frequency offset estimate.

In operation, the preamble-based frequency offset estimator 302 performs self-correlation between the first slot block, i.e., the slots 1 and 2, and the second slot block, i.e., the slots 2 and 3, of the time-domain preamble to derive r₁. The frequency offset estimator also performs self-correlation between the slot 1 and the slot 3 of the time-domain preamble to derive r₂.

In an embodiment, the preamble-based frequency offset estimator 302 then multiplies r₁ and r₂ to derive r₃, which is used to calculate φ₃. The preamble-based frequency offset estimator 302 then computes the preamble-based frequency offset estimate using φ₃ and Equation 1.

In an alternative embodiment, the preamble-based frequency offset estimator 302 then calculates φ₁ and φ₂ using r₁ and r₂, respectively. The preamble-based frequency offset estimator 302 then adds φ₁ and φ₂ to derive φ₃. The preamble-based frequency offset estimator 302 then compares φ₃ to π and −π to resolve the ambiguity problem. The resultant phase is then used to compute the preamble-based frequency offset estimate using Equation 1.

The CP-based frequency offset estimator 304 is configured to compute the CP-based frequency offset estimate. As illustrated in FIG. 5, an OFDM symbol 500 includes a CP 502, which is a repeat of an end portion 504 of the symbol at the beginning of the symbol. Thus, the CP 502 and the corresponding end portion 504 of the OFDM symbol 500 are the same. The OFDM symbol 500 can be any type of OFDM symbol, including a preamble. The CP-based frequency offset estimator 304 is configured to perform self-correlation between at least a portion 506 of the CP 502 and a corresponding portion 508 of that CP portion. The result of the self-correlation can be denoted as r_{CP}. The phase of this self-correlation, φ_{CP}, is then calculated using the equation, r_{CP}=e^{jφ}^{_{CP}}. The CP-based frequency offset estimator 304 then computes an estimated frequency offset based on CP, f_{CP}, using:

$${f}_{CP} = \frac{{ϕ}_{CP}}{2 π} Δ f , \qquad ( Equation 2 )$$

where Δf is the subcarrier spacing.

Because CP is potentially useful for automatic gain control (AGC) and the beginning section of CP contains inter-symbol interference (ISI) from the preceding OFDM symbol, a predefined beginning section of the CP may be reserved and not used for self-correlation. Thus, in these embodiments, only samples from the remaining section (non-reserved) of the CP is used to perform self-correlation with samples from a corresponding end section of the OFDM symbol, as illustrated in FIG. 5. However, in other embodiments, the entire CP may be used to perform self-correlation with the corresponding end portion of the OFDM symbol. Furthermore, in some embodiments, the self-correlation results are accumulated across several OFDM symbols to get a better estimate.

The pilot-based frequency offset estimator 306 is configured to compute the pilot-based frequency offset estimate. Pilot subcarriers are known signals embedded in OFDM signals and are widely used for channel estimation. In the tracking mode, if the frequency offset is not too large, and if the channel is not fading too fast, the frequency offset embodies itself as a phase shift on the pilot subcarriers at the same subcarrier across different OFDM symbols. Thus, a frequency offset estimate can be computed using the pilot subcarriers in the OFDM symbols.

In operation, the pilot-based frequency offset estimator 306 computes phase differences between all pilot subcarriers at the same subcarrier location and separated in the time domain by m number of OFDM symbols, where m is a small number including one (thus, pilot subcarriers in adjacent OFDM symbols may be used), across multiple subcarriers and across multiple OFDM symbols in at least one frame. For example, if the received pilot subcarriers at subcarrier location k in OFDM symbol n is yₖ(n), and the received pilot subcarriers at subcarrier location k in OFDM symbol n+m is yₖ(n+m), then the correlation rₖ(n)=yₖ(n)yₖ*(n+m), and the phase difference, φₖ(n), between the two symbols is angle of rₖ(n).

The pilot-based frequency offset estimator 306 then averages all the computed phase differences across multiple subcarriers in one OFDM symbol and across multiple OFDM symbols. The averaging can be performed on the complex correlations rₖ(n). In this case, the averaged rₖ(n) is defined to be rₚᵢₗₒₜ, and the phase of rₚᵢₗₒₜ is defined to be φₚᵢₗₒₜ, i.e., rₚᵢₗₒₜ=e^{jφ}^{ₚᵢₗₒₜ}, where φₚᵢₗₒₜ is the desired average phase difference. Alternatively, the averaging can be performed on the phase of the complex correlations φₖ(n). In this case, φₚᵢₗₒₜ is defined to be the averaged φₖ(n).

The pilot-based frequency offset estimator 306 then transforms the average phase difference, φₚᵢₗₒₜ, into a pilot-based frequency offset estimate using time separation between the two OFDM symbols which contain the pilot subcarriers. The pilot-based frequency offset estimate can be computed using:

$${f}_{pilot} = \frac{{ϕ}_{pilot}}{2 π ( 1 + g ) m} Δ f$$

where Δf is the subcarrier spacing and g is the length of CP divided by the length of an OFDM symbol (excluding CP), i.e., g is the normalized length of CP.

The averaging unit 308 is connected to the preamble-based frequency offset estimator 302, the CP-based frequency offset estimator 304 and the pilot-based frequency offset estimator 306 to receive the different frequency offset estimates. In this embodiment, the averaging unit 308 computes a final frequency offset estimate, fₒ, which is a weighted sum of frequency offset estimates from the preamble-based frequency offset estimator 302, the CP-based frequency offset estimator 304 and the pilot-based frequency offset estimator 306. The final frequency offset estimate, fₒ, can be mathematically expressed as:

fₒ=w₁f_{preamble}+w₂f_{CP}+w₃fₚᵢₗₒₜ,

where w₁, w₂, and w₃ are weights, which may or not be equal to each other.

The adaptive IIR filter 310 is connected to the averaging unit 308 to receive the final frequency offset estimate, fₒ, which is an instantaneous frequency offset estimate. Since instantaneous frequency offset estimate is usually noisy, the adaptive IIR filter 310 operates to suppress noise. However, there is a tradeoff between noise suppression and convergence speed when using any filter. The adaptive IIR filter 310 achieves fast convergence, while providing satisfactory noise suppression.

In an embodiment, the adaptive IIR filter 310 is a simple one-tap IIR filter to average instantaneous frequency offset estimates, fₒ, from the averaging unit. If the averaged frequency offset estimate at frame n is denoted as f[n] and the instantaneous frequency offset estimate of frame n+1 is denoted as fₒ, then the averaged frequency offset estimate at frame n+1 is given by:

f[n+1]=(1−α)f[n]+αfₒ,

where 0≦α≦1 is filter coefficient. At the initial tracking stage, α is set to a large value, so that the averaging process converges quickly. As the averaging gets close to convergence, α is set to a smaller value to sufficiently suppress noise. Criteria to change α are either one of the following or a combination of the following:
a) Frame number in the tracking mode. The filter coefficient, α, can be decreased as the number of frames for which the receiver has been in the tracking mode increases.
b) Estimated frequency offset. If the estimated frequency offset is large, a large value for α is used, otherwise a smaller value of α is used.

In an alternative embodiment, the preamble-based frequency offset estimator 302 is configured to output the product, r₃, of the self-correlations, r₁ and r₂, which is a complex quantity. In this embodiment, the preamble-based frequency offset estimator 302 does not compute φ₃ or f_{preamble}. Similarly, the CP-based frequency offset estimator 304 is configured to output r_{CP}, which is also a complex quantity. The CP-based frequency offset estimator 304 does not compute φ_{CP} or f_{CP}. Likewise, the pilot-based frequency offset estimator 306 is configured to output rₚᵢₗₒₜ, which is also a complex quantity. The pilot-based frequency offset estimator 306 does not compute φₚᵢₗₒₜ or fₚᵢₗₒₜ.

In this embodiment, the averaging unit 308 receives r₃, r_{CP} and rₚᵢₗₒₜ, which are combined through a weight sum to produce a quantity r using the following equation:

r=w₁r₃+w₂r_{CP}+w₃rₚᵢₗₒₜ

where w₁, w₂, and w₃ are weights, which can be complex numbers to correct theoretical phase difference between r₃, r_{CP}, and rₚᵢₗₒₜ. The averaging unit 308 then computes the phase, φ, of r using r=e^{jφ}. The final instantaneous frequency offset estimate, fₒ, can then be computed as using:

$${f}_{o} = \frac{ϕ}{2 π} Δ f .$$

where Δf is the subcarrier spacing.

In the above-described embodiments, the frequency offset estimator 202 is configured to use all three frequency offset estimates, f_{preamble}, f_{CP} and or all three correlation results, r₃, r_{CP} and rₚᵢₗₒₜ. However, in other embodiments, the frequency offset estimator 202 may be configured to compute only one of the three frequency offset estimates, f_{preamble}, f_{CP} and fₚᵢₗₒₜ, and then use that frequency offset estimate to produce the final frequency offset estimate. In other embodiments, the frequency offset estimator 202 may be configured to use any two of the three frequency estimates, f_{preamble}, f_{CP} and fₚᵢₗₒₜ, and then use the two frequency offset estimates to produce the final frequency offset estimate. In still other embodiments, the frequency offset estimator 202 may be configured to use any two of the three correlation results, r₃, r_{CP} and rₚᵢₗₒₜ, and then use the two correlation results to produce the final frequency offset estimate.

The frequency offset averaging performed by the frequency offset estimator 202 can be applied in both tracking and acquisition mode. The receiver 102 can stay in acquisition mode for multiple frames, and the frequency offset estimator can obtain an averaged frequency offset estimate, which is usually more accurate than non-averaged single-frame frequency offset estimate. By performing multi-frame acquisition and frequency offset averaging, there will be a smaller residual frequency offset when the receiver 102 enters tracking mode.

Multi-frame acquisition can not only be utilized to obtain averaged frequency offset estimate, it can also be utilized to obtain a robust decision on the strongest BS, which is executed by the BS selector 204 of the synchronization module 108. In an embodiment, the BS selector 204 picks the BS that has a largest signal strength or CINR for each frame during a multi-frame acquisition mode, and stores the index of that BS in a buffer. At the end of a pre-specified number of frames, the BS selector 204 chooses the BS index that appears most often in the buffer as the strongest BS. In another embodiment, for each BS, the BS selector 204 accumulates signal strength or CINR measured in each frame. At the end of a pre-specified number of frames, the BS selector 204 chooses the BS that has the largest accumulated signal strength or CINR as the strongest BS, and synchronizes to the chosen BS.

In both embodiments, the timing offset estimate that the receiver 102 uses is from the last time the selected BS appears to be the strongest among all BSs.

The averaging process of frequency offset estimate should also be reset whenever a false detection is identified, which is executed by the false detection identifier 206 of the synchronization module 108. The false detection identifier 206 is configured to identify false detection based on thresholds on the following five quantities:
a) Time-domain signal energy, i.e.,

$${\sum }_{i} {λ}_{i} {\sum }_{n} {\vert {x}^{( i )} ( n ) \vert}^{2} ,$$

where x⁽ⁱ⁾(n) (output of the ADC 118) is the preamble sample in the time-domain at time instance n on antenna i, {λᵢ} are combining coefficients, and the summation is first over the whole preamble or a fixed subset of preamble, then over the receive antennas.
b) Magnitude of time-domain self correlation between a first block of slots 1 and 2 and a second block of slots 2 and 3 normalized by time-domain energy. The self correlation is first computed for each receive antenna, then combined across all receive antennas using the combining coefficients {λᵢ}
c) Magnitude of time-domain self correlation between slot 1 and slot 3 normalized by time-domain energy. The self correlation is first computed for each receive antenna, then combined across all receive antennas using the combining coefficients {λᵢ}.
d) Frequency-domain signal power of the serving BS. The power is first computed for each receive antenna, then combined across all receive antennas using the combining coefficients {λᵢ} This power can be measured using any appropriate method.
e) Frequency-domain signal power of the serving BS normalized by frequency-domain energy in the segment of the serving BS. Let X⁽ⁱ⁾(n) be the frequency-domain subcarriers on antenna i (output of the Fast Fourier Transformer 122). The frequency-domain energy is computed as

$${\sum }_{i} {λ}_{i} {\sum }_{n ∈ the segment of serving BS} {\vert {X}^{( i )} ( n ) \vert}^{2} .$$

Whenever any of these measured quantities does not surpass the threshold, a false detection alarm is declared. The false detection identifier 206 identifies that a false detection has happened and resets the averaging of frequency offset estimate if one of the following two conditions is met:
i) If false detection alarm is declared in M consecutive frames;
ii) If out of M consecutive frames, there are at least N (N≦M) frames in which a false detection alarm is declared.

Note that when a false detection is identified, resetting frequency offset estimate averaging may not be the only thing that the device 100 does. For example, the device 100 may choose to go back to acquisition mode when a false detection is identified.

The averaging process of frequency offset estimate should be stopped or reset whenever the presence of a strong blocker signal is detected, which is performed by the blocker detector 208. The blocker detector 208 operates to perform one of the two block detection processes:

(a) Blocker detection based on in-band energy. Thresholds on time-domain signal energy and frequency-domain signal power of the serving BS help to identify if blocker level is high. This is because of the way automatic gain control (AGC) works. Assume that AGC tries to amplify the received signal to a fixed target power level P_{target}. Denote the AGC gain as G, the measured signal energy in the receiver digital domain as P_{time-domain}, the energy of signal inside the receiver's bandwidth as P_{inband}_{_{—}}_{signal}, total signal energy measured by AGC before receiver filtering as Pₜₒₜₐₗ. Then the following relationship holds:

P_{time-domain}=P_{inband}_{_{—}}_{signal}*G=P_{inband}_{_{—}}_{signal}/Pₜₒₜₐₗ*P_{target}

If the signal at the input of AGC consists mainly of valid OFDMA signal, then after receiver filtering, the signal should remain largely unchanged. On the contrary, if the signal at the input of AGC has a large blocker component, the component will be largely attenuated by receiver filtering, and Pₜₒₜₐₗ measured by AGC is much larger than P_{inband}_{_{—}}_{signal} measured by the digital part of the receiver. Therefore, the ratio P_{inband}_{_{—}}_{signal}/Pₜₒₜₐₗ and the resultant P_{time-domain} is large for signal, and small for blocker. Blocker can be detected if P_{time-domain} does not pass a threshold. The threshold on frequency-domain signal strength of the serving BS works similarly.

(b) Blocker detection based on normalized energy in guard band. OFDMA signal usually has guard bands at both ends of the spectrum, where no preamble or data subcarrier is located. Without blocker, the energy in the guard band is comparable to noise floor. When there is a strong blocker that leaks power into OFDMA bands, the guard bands have much stronger energy than noise floor. By measuring power in the guard bands, normalizing the measured power by in-band signal power, and comparing to a threshold, the blocker detector 208 can effectively detect presence of strong blocker. When measuring energy in guard bands, several subcarriers closest to the preamble or signal subcarriers should not be measured because when there is a frequency offset, those subcarriers may contain signal component. In an exemplary system with 1024 subcarriers, let the number of guard band subcarriers on the left side of the spectrum be N, and let the number of guard band subcarriers on the right side of the spectrum be M. Let X⁽ⁱ⁾(n) be the frequency-domain subcarriers on antenna i. The normalized guard band energy can then be computed as

$$\frac{{\sum }_{i} {λ}_{i} ( {\sum }_{n = 1}^{N - {K}_{1}} {\vert {X}^{( i )} ( n ) \vert}^{2} + {\sum }_{n = 1024 - M + {K}_{2}}^{1024} {\vert {X}^{( i )} ( n ) \vert}^{2} )}{{\sum }_{i} {λ}_{i} {\sum }_{n = N}^{1024 - M} {\vert {X}^{( i )} ( n ) \vert}^{2}} ,$$

where K₁ and K₂ are non-negative constants. The first term in the summation in the numerator is over subcarriers in the left guard band, and the second term in the summation in the numerator is over subcarriers in the right guard band.

Note when strong blocker signal is detected, stopping or resetting the frequency offset estimate averaging may not be the only thing that the device 100 does. For example, the device 100 may choose to go back to acquisition, or to switch to another frequency area and restart acquisition.

The CINR calculation unit 210 is configured to calculate CINR, which can be used as part of the multi-frame acquisition, e.g., BS selection by the BS selector 204, or for other proper uses (e.g., reporting to serving BS as requested by mobile WiMAX standard). Note that the procedure described below can be utilized to calculate CINR of any BS, not just the serving BS.

An illustration of frequency-domain preamble in a WiMAX system is shown in FIG. 6. The preamble of any BS only occupies every the third sub carrier.

The signal power is estimated through differential cross correlation. Let Yₖ be the frequency-domain received signal on subcarrier k, and pₖ be the pseudo-noise (PN) preamble sequence of the interested BS on subcarrier k. The CINR calculation unit 210 first removes the preamble by multiplying the preamble sequence with the frequency-domain data on all subcarriers where the preamble of the interested BS is non-zero:

Xₖ=Yₖpₖ.

Then the following differential correlation is performed:

$$R = {\sum }_{k} {X}_{k} {X}_{k + 3}^{*} ,$$

where the summation is on all subcarriers where the preamble of the interested BS is non-zero. The signal power is simply the absolute value of R: |R|.

The CINR calculation unit 210 uses high pass filtering in the frequency domain to estimate interference-and-noise power, and use noise floor tracking to differentiate interference power from noise power.

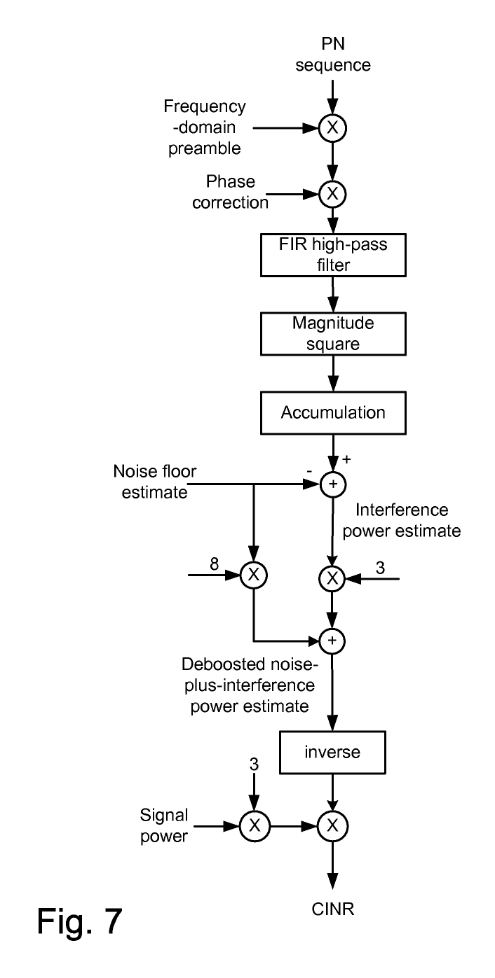

The CINR calculation unit 210 measures signal power at the input of AGC in a time window located in the receive/transmit transition gap (RTG). This is the estimated noise floor. The CINR is estimated using the following procedure, as illustrated in FIG. 7.

As shown in FIG. 7, the frequency domain preamble symbol {Yₖ} is multiplied by the PN sequence {pₖ} of the interested BS, to get the PN-removed sequence {Xₖ}, as explained above. The result is then multiplied by a phase sequence to correct the phase shift in the frequency domain caused by timing shift, i.e., the following operation is performed:

Xₖe^{j(k-1)∠R},

where the quantity R is the differential correlation result defined above.

The result is passed to a finite impulse response (FIR) high-pass filter, and the filter output is magnitude squared, and then summed up. This is the estimated interference-and-noise power. The noise floor is then subtracted from the interference-and-noise power, which results in the interference power estimate. If this value is negative, then a value of zero is instead used as the interference power estimate.

The noise floor is then multiplied by a factor, e.g., 8, and then added with the interference power estimated. The result is deboosted interference-and-noise power. The CINR is defined as signal power, which is multiplied by a factor, e.g., 3, divided by deboosted interference-and-noise power.

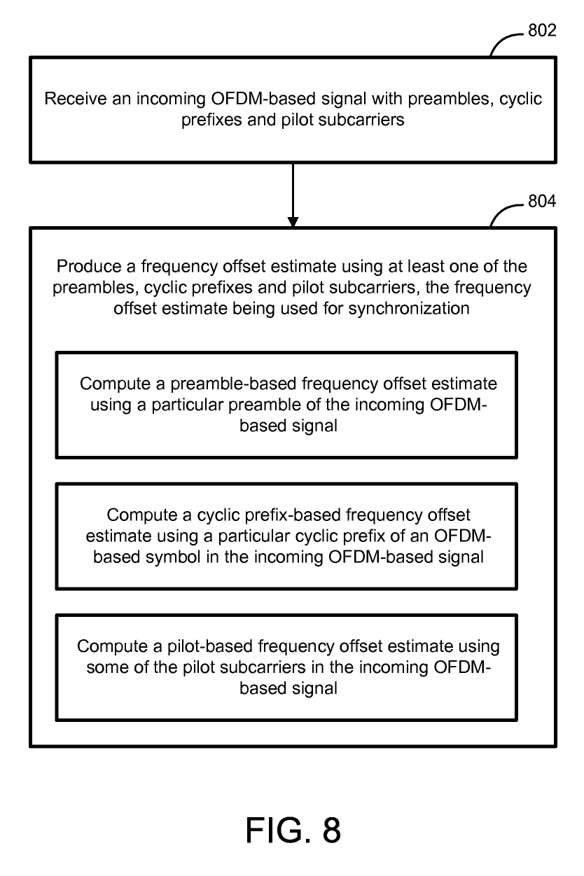

A method for performing synchronization for an OFDM-based device in accordance with an embodiment of the invention is described with reference to a flow diagram of FIG. 8. At block 802, an incoming OFDM-based signal with preambles, cyclic prefixes and pilot subcarriers is received. At block 804, a frequency offset estimate is produced using at least one of the preambles, cyclic prefixes and pilot subcarriers, the frequency offset estimate being used for synchronization. The producing of the frequency offset estimate includes at least one of the following:

(a) Computing a preamble-based frequency offset estimate using a particular preamble of the incoming OFDM-based signal. The particular preamble includes first, second and third slots. The computing of the preamble-based frequency offset estimate includes computing a phase difference between the first slot and third slot and a phase difference between a first block of the first and second slots and a second block of the second and third slots;

(b) Computing a cyclic prefix-based frequency offset estimate using a particular cyclic prefix of an OFDM-based symbol in the incoming OFDM-based signal. The computing of the cyclic prefix-based frequency offset estimate includes computing a correlation between at least a portion of the particular cyclic prefix with a corresponding end portion of the OFDM-based symbol; and

(c) Computing a pilot-based frequency offset estimate using some of the pilot subcarriers in the incoming OFDM-based signal. The computing of the pilot-based frequency offset estimate includes computing a phase difference between pilot subcarriers at a particular subcarrier location and in different OFDM-based symbols and averaging phase differences across multiple pilot subcarrier locations and across multiple OFDM-based symbols.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for performing synchronization for an OFDM-based device, the method comprising:
receiving an incoming OFDM-based signal with preambles, cyclic prefixes and pilot subcarriers; and
producing a frequency offset estimate using at least one of the preambles, cyclic prefixes and pilot subcarriers, the frequency offset estimate being used for synchronization, the producing including at least one of:
computing a preamble-based frequency offset estimate using a particular preamble of the incoming OFDM-based signal, the particular preamble including first, second and third slots, the computing the preamble-based frequency offset estimate including computing a phase difference between the first slot and third slot and a phase difference between a first block of the first and second slots and a second block of the second and third slots;
computing a cyclic prefix-based frequency offset estimate using a particular cyclic prefix of an OFDM-based symbol in the incoming OFDM-based signal, the computing the cyclic prefix-based frequency offset estimate including computing a correlation between at least a portion of the particular cyclic prefix with a corresponding end portion of the OFDM-based symbol; and
computing a pilot-based frequency offset estimate using some of the pilot subcarriers in the incoming OFDM-based signal, the computing the pilot-based frequency offset estimate including computing a phase difference between the pilot subcarriers at a particular subcarrier location and in different OFDM-based symbols and averaging phase differences across multiple pilot subcarrier locations and across multiple OFDM-based symbols.

2. The method of claim 1 wherein the producing includes at least two of the computing the preamble-based frequency offset estimate, the computing the cyclic prefix-based frequency offset estimate and the computing the pilot-based frequency offset estimate.

3. The method of claim 2 wherein the producing includes each of the computing the preamble-based frequency offset estimate, the computing the cyclic prefix-based frequency offset estimate and the computing the pilot-based frequency offset estimate.

4. The method of claim 2 wherein the producing further includes averaging at least two of the preamble-based frequency offset estimate, the cyclic prefix-based frequency offset estimate and the pilot-based frequency offset estimate to produce an averaged estimate.

5. The method of claim 4 wherein the producing further includes applying Infinite Impulse Response filter to a plurality of averaged estimates across multiple frames of the incoming OFDM-based signal.

6. The method of claim 1 wherein the producing includes the computing the cyclic prefix-based frequency offset estimate, the computing the cyclic prefix-based frequency offset estimate includes not using a portion of the particular cyclic prefix that contains inter-symbol interference information.

7. The method of claim 1 wherein the producing includes the computing the preamble-based frequency offset estimate, the computing the cyclic prefix-based frequency offset estimate and the computing the pilot-based frequency offset estimate.

8. The method of claim 1 further comprising selecting a serving base station, the selecting including at least one of:
picking one of a plurality of base stations that most often has the largest signal strength or CINR in each frame of a pre-specified number of frames; and
choosing one of the plurality of base stations that has the largest accumulated signal strength or CINR during the pre-specified number of frames.

9. The method of claim 1 further comprising identifying a false detection using at least one threshold on one of:
time-domain signal energy;
magnitude of time-domain self-correlation between a first block of first and second slots of a preamble and a second block of the second slot and a third slot normalized by time-domain energy;
magnitude of time-domain self-correlation between the first and third slots of the preamble normalized by the time-domain energy;
frequency-domain signal power of a serving base station; and
the frequency-domain signal power of the serving base station normalized by frequency-domain energy.

10. The method of claim 1 further comprising detecting a blocker signal, the detecting including at least one of:
comparing measured signal energy in a receiver digital domain to a threshold; and
comparing measured power in guard bands that is normalized by in-band signal power to another threshold.

11. The method of claim 1 further comprising calculating carrier-to-interference-plus-noise-ratio (CINR) using high pass filtering in the frequency domain to estimate interference-and-noise power and using noise floor tracking to differentiate interference power from noise power.

12. An OFDM-based device comprising:
a frequency offset estimator configured to produce a frequency offset estimate using at least one of preambles, cyclic prefixes and pilot subcarriers of an OFDM-based signal, the frequency offset estimator comprising at least one of:
a preamble-based frequency offset estimator configured to compute a preamble-based frequency offset estimate using a particular preamble of the incoming OFDM-based signal, the particular preamble including first, second and third slots, the preamble-based frequency offset estimator being configured to compute a phase difference between the first slot and third slot and a phase difference between a first block of the first and second slots and a second block of the second and third slots to compute the preamble-based frequency offset estimate;
a cyclic prefix-based frequency offset estimator configured to compute a cyclic prefix-based frequency offset estimate using a particular cyclic prefix of an OFDM-based symbol in the incoming OFDM-based signal, the cyclic prefix-based frequency offset estimator being configured to compute a correlation between at least a portion of the particular cyclic prefix with a corresponding end portion of the OFDM-based symbol to compute the cyclic prefix-based frequency offset estimate; and
pilot-based frequency offset estimator configured to compute a pilot-based frequency offset estimate using some of the pilot subcarriers in the incoming OFDM-based signal, the pilot-based frequency offset estimator being configured to compute a phase difference between the pilot subcarriers at a particular subcarrier location and in different OFDM-based symbols and average phase differences across multiple pilot subcarrier locations and across multiple OFDM-based symbols.

13. The device of claim 12 wherein the frequency offset estimator includes at least two of the preamble-based frequency offset estimator, the cyclic prefix-based frequency offset estimator and the pilot-based frequency offset estimator.

14. The device of claim 13 wherein the frequency offset estimator includes each of the preamble-based frequency offset estimator, the cyclic prefix-based frequency offset estimator and the pilot-based frequency offset estimator.

15. The device of claim 13 wherein the frequency offset estimator further includes an averaging unit operable connected to at least two of the preamble-based frequency offset estimator, the cyclic prefix-based frequency offset estimator and the pilot-based frequency offset estimator, the averaging unit being configured to average at least two of the preamble-based frequency offset estimate, the cyclic prefix-based frequency offset estimate and the pilot-based frequency offset estimate to produce an averaged estimate.

16. The device of claim 15 wherein the frequency offset estimator further includes an Infinite Impulse Response filter to filter a plurality of averaged estimates across multiple frames of the incoming OFDM-based signal.

17. The device of claim 12 wherein the frequency offset estimator includes the cyclic prefix-based frequency offset estimator, the cyclic prefix-based frequency offset estimator being configured to not use a portion of the particular cyclic prefix that contains inter-symbol interference information to compute the cyclic prefix-based frequency offset.

18. The device of claim 12 wherein the frequency offset estimator includes the preamble-based frequency offset estimator, the cyclic prefix-based frequency offset estimate and the pilot-based frequency offset estimate.

19. The device of claim 12 further comprising a base station selector, the base station selector being configured to select a base station by executing at least one of:
picking one of a plurality of base stations that most often has the largest signal strength or CINR in each frame of a pre-specified number of frames; and
choosing one of the plurality of base stations that has the largest accumulated signal strength or CINR during the pre-specified number of frames.

20. The device of claim 12 further comprising a false detection identifier, the false detection identifier being configured to identify a false detection using at least one threshold on one of:
time-domain signal energy;
magnitude of time-domain self-correlation between a first block of first and second slots of a preamble and a second block of the second slot and a third slot normalized by time-domain energy;
magnitude of time-domain self-correlation between the first and third slots of the preamble normalized by the time-domain energy;
frequency-domain signal power of a serving base station; and
the frequency-domain signal power of the serving base station normalized by frequency-domain energy.

21. The device of claim 12 further comprising a blocker detector configured to detect a blocker signal by executing at least one of:
comparing measured signal energy in a receiver digital domain to a threshold; and
comparing measured power in guard bands that is normalized by in-band signal power to another threshold.

22. The device of claim 12 further comprising a carrier-to-interference-plus-noise-ratio (CINR) calculation unit configured to compute CINR using high pass filtering in the frequency domain to estimate interference-and-noise power and using noise floor tracking to differentiate interference power from noise power.
